(19) United States
(12) Patent Application Publication
(10) Pub. No.: US 2012/0089641 A1
(43) Pub. Date: Apr. 12, 2012

(54) SEARCHING TRAVEL RECORDS

(75) Inventors: Justin Steven Wilde, Salt Lake City, UT (US); Jeffrey R. Wilde, Sandy, UT (US); James Ted Geyerman, Lindon, UT (US)

(73) Assignee: ACCENTURE GLOBAL SERVICES LIMITED, Dublin 4 (IE)

(21) Appl. No.: 12/900,625

(22) Filed: Oct. 8, 2010

(51) Int. Cl. G06F 17/30

(52) U.S. Cl. 707/771; 707/E17.014; 707/E17.089

(57) ABSTRACT

A free-form user-generated search query is used to retrieve responsive travel record information from categorized travel records. Searching the categorized travel records includes parsing the search query to identify search terms, determining a category with which each search term is associated, searching the categorized records to identify travel records that include responsive information. Systems and graphical user interfaces for searching travel records are also disclosed.

### TECHNICAL FIELD

This disclosure relates to searching travel records.

### BACKGROUND

Various forms of travel, including airline travel, rail travel, and bus travel, among others, are frequently used by individuals that need to travel from one location to another. Services on these and other forms of travel often are often purchased weeks or months in advance of a scheduled travel date and travel service providers rely on reservations or bookings to manage information regarding travel service sales. Electronic records associated with reservations or bookings can be used as a convenient medium for storing such information, and can be accessed from remote locations using computer networks.

### SUMMARY

In many situations, the volume or information included in a repository of electronic records for travel service providers can make identifying and retrieving desired information very difficult or slow. In order to allow users to quickly identify relevant reservation or booking information, electronic travel records can be categorized. When a user searches for one or more particular records, a search query provided by the user can be analyzed to determine which category or categories should be search for information that matches the user-provided search terms. In this way, relevant information can be identified and returned to the user without requiring the user to input the search query in a particular format or syntax or to provide search logic.

In one general aspect, a method includes receiving a search query including at least one search term relating to information included in travel records, identifying, by one or more computer processors, one or more search terms included in the search query, determining, for at least one identified search term included in the search query by one or more computer processors, a category of travel information associated with the search term by analyzing a format of the search term and selecting a category of travel information according to a predetermined set of categorization rules, retrieving, from a travel record repository by one or more computer processors, information regarding one or more travel records, the one or more travel records including information for the determined category of travel information that at least partly matches at least part of the search query, and outputting the retrieved information in response to the search query.

Implementations can include one or more of the following features. For example, identifying one or more search terms includes analyzing a syntax of the search query to identify a pattern that corresponds to a search term. The predetermined set of categorization rules includes one or more rules regarding selecting a category to be applied to the search term when the search term meets one or more criteria associated with at least two categories. The category of travel information is selected from a predetermined set of possible categories. The predetermined set of possible categories includes at least one of departure time, travel destination location, traveler name, travel record identifier, customer program account number, and a provider identifier. The received query includes a free-form user-generated query. The travel record repository includes categorized information for travel records. Retrieving information regarding one or more travel records includes retrieving information from the travel record repository according to a search rule associated with the determined category. The travel records are associated with pending or completed sale transactions of one or more affiliated providers of travel-related goods and/or services. Determining a category of travel information includes determining that an identified search term included in the search query consisting of three letters is associated with a destination category.

In another general aspect, a system includes one or more receivers that receive a search query including at least one search term relating to information included in travel records, one or more computer processors that identify one or more search terms included in the search query, determine, for at least one identified search term included in the search query, a category of travel information associated with the search term by analyzing a format of the search term and selecting a category of travel information according to a predetermined set of categorization rules, and retrieve, from a travel record repository, information regarding one or more travel records, the one or more travel records including information for the determined category of travel information that at least partly matches at least part of the search query, and one or more output devices that output the retrieved information.

Implementations can include one or more of the following features. For example, identifying one or more search terms includes analyzing a syntax of the search query to identify a pattern that corresponds to a search term. The predetermined set of categorization rules includes one or more rules regarding selecting a category to be applied to the search term when the search term meets one or more criteria associated with at least two categories. The category of travel information is selected from a predetermined set of possible categories. The predetermined set of possible categories includes at least one of departure time, travel destination location, traveler name, travel record identifier, customer program account number, and a provider identifier. The received query includes a free-form user-generated query. The travel record repository includes categorized information for travel records. The travel records are associated with pending or completed sale transactions of one or more affiliated providers of travel-related goods and/or services. The system can also include one or more storage devices that store information included in the travel record repository.

In another general aspect, a tangible computer-readable medium includes computer software stored thereon, the computer software including computer-executable instructions that, when executed by one or more computer processors, cause one or more computer systems to receive a search query including at least one search term relating to information included in travel records, identify, by one or more computer processors, one or more search terms included in the search query, determine, for at least one identified search term included in the search query by one or more computer processors, a category of travel information associated with the search term by analyzing a format of the search term and selecting a category of travel information according to a predetermined set of categorization rules, retrieve, from a travel record repository by one or more computer processors, information regarding one or more travel records, the one or more travel records including information for the determined category of travel information that at least partly matches at least part of the search query, and output the retrieved information in response to the search query.

In another general aspect, a tangible computer-readable medium includes computer software stored thereon, the computer software including computer-executable instructions that, when executed by one or more computer processors, cause one or more computer systems to provide a first user interface having a search text input field and an advanced search control, receive information regarding user input in the search text input field and an indication that the advanced search control was selected, and provide a second user interface having categorized input entry fields, wherein at least one of the categorized input entry field is automatically populated based on the received information.

The details of one or more implementations are set forth in the accompanying drawings and the description below. Other features will be apparent from the description and drawings, and from the claims.

### DESCRIPTION OF DRAWINGS

FIG. 1 is a diagram illustrating a system for searching categorized records.

FIG. 2 is an illustration of a process for searching categorized records.

FIG. 3 is a diagram illustrating a system for searching categorized travel records.

FIGS. 4-6 are illustrations of data structures for use in searching categorized records.

FIG. 7 is an illustration of a process for searching categorized travel records.

FIG. 8 is a diagram of a computer system useful in the system of FIGS. 1 and 3.

FIGS. 9-11 are illustrations of user interfaces for use in searching categorized travel records.

Like reference symbols in the various drawings indicate like elements.

### DETAILED DESCRIPTION

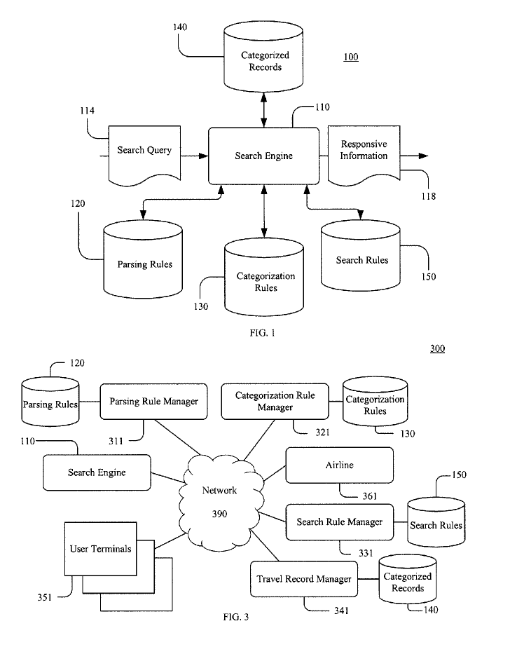

FIG. 1 illustrates a system 100 for searching categorized records and returning as results records that are responsive to a search query. The system 100 includes a search engine 110 that receives a search query 114 and returns responsive information 118. For example, information regarding one or more categorized records is returned as responsive information by the search engine 110. The system 110 also includes a parsing rule repository 120, categorization rule repository 130, a categorized record repository 140, and a search rule repository 150.

The parsing rule repository 120 stores one or more parsing rules that are used by the search engine 110 to identify one or more search terms included in the received search query 114. For example, the search engine 110 can identify groups of characters bounded by separation characters as search terms. The categorization rule repository 130 stores one or more categorization rules that are used by the search engine 110 to analyze the format of at least one identified search term to determine a category of information associated with the at least one identified search term. The category of information associated with the identified search term may be determined from among a predetermined set of possible categories. For example, the predetermined set of possible categories may be the full set or a reduced set of all of the categories of categorized records stored in a categorized record repository 140. Additionally, if a search term meets one or more criteria associated with two or more categories, the categorization rules may be used by the search engine 110 to determine which of the two or more categories to associate with the term.

The categorized record repository 140 stores information regarding records, such as customer information and/or sales information. The information of the records is categorized into one of multiple categories of information, such as name information, date information, product information, and payment information, among others. The search rule repository 150 stores one or more search rules that are used by the search engine to determine which records are responsive to the search query.

In use, the search engine 110 identifies responsive records from among the categorized records of the categorized record repository 140 by identifying one or more of the categorized records that include information for the determined category that at least partly matches one or more search terms associated with the determined category. The responsive records are identified from among the categorized records according to one or more of the search rules associated with the determined category. The search engine 110 outputs information of one or more responsive records as the responsive information 118 though a user interface. For example, the search engine 110 retrieves information associated with the responsive records from the categorized record repository and displays information associated with one or more categories for one or more of the responsive records.

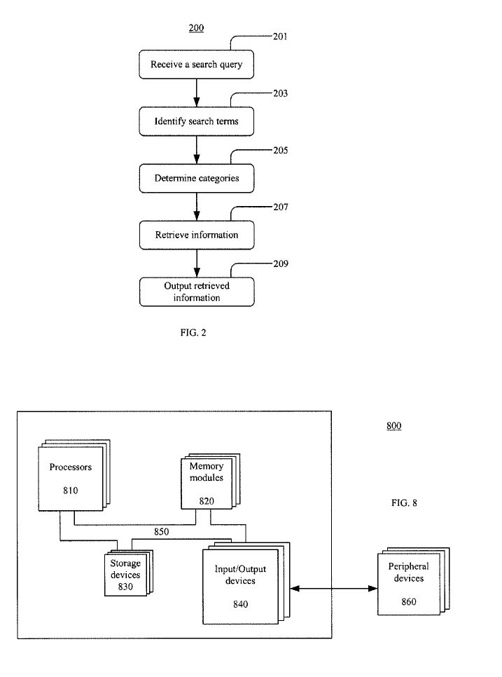

In some implementations, the search engine 110 searches categorized records according to a process 200, illustrated in FIG. 2. Specifically, the search engine 110 receives a search query, such as the search query 114 (201). The search query 114 is input by a user through a user interface and is provided to the search engine 110. The search query 114 is a free-form user-generated query that is provided without a required format associated with a category of information to which the term is directed. For example, a user can use a search control of the user interface to enter a free-form query in natural language.

After receiving the search query, the search engine 110 identifies one or more search terms included in the received search query (203). For example, the search engine 110 accesses parsing rules from the parsing rule repository 120 and identifies one or more search terms included in the search query according to one or more accessed parsing rules. In some implementations, a parsing rule specifies that search terms are one or more characters that are bounded by spaces, another separation character, or the beginning or end of the search query. Thus, parsing an input search query “John Smith” according to the parsing rule would yield a first search term of “John” and a second search term of “Smith”. However, other parsing rules can additionally or alternatively be used, including parsing rules that combine groups of characters, add characters to groups of characters, and/or remove characters from groups of characters.

The search engine 110 determines, for at least one search term identified from the search query, one or more category of information associated with the identified search term (205). For example, the search engine 110 accesses categorization rules stored in the categorization rule repository 130 and associates each search term identified in the search query with a category of the categorized records according to the categorization rules. In some implementations, the format of a search term can be analyzed and compared to predetermined format associated with a particular category of information according to a categorization rule. For example, a categorization rule associated with a “time” category of information causes the search engine 110 to associate a search term with the “time” category if the search term contains at least one number and a colon character.

If an identified search term meets one or more criteria associated with two or more matching categories, the search engine 110 may use one or more categorization rules to select a category to associate with the search term, and the search term is not associated with any other categories. In some implementations, the search term can be associated with each of the two or more matching categories. In other implementations, the search term can be associated with one or more, but not all, of the two or more categories. For example, a categorization rule can cause a search term to be associated with a selected first one of the two categories if a search term satisfies criteria of categorization rules for the first category and a second category.

If an identified search term does not meet criteria for association with any category, the identified search term can be disregarded. Alternatively, the identified search term can be associated with all categories, or one or more predetermined default categories. In some implementations, the identified search term can be processed in an attempt to modify the identified search term such that the modified term satisfies criteria for association with at least one category.

After categorizing one or more identified search terms, the search engine 110 retrieves information included in the one or more responsive records (207) and outputs the retrieved information in response to the search query (209). For example, all information associated with a responsive record is retrieved and is displayed in a user interface. If the retrieved information includes information regarding two or more records, the retrieved information for each responsive record is displayed in a portion of the user interface associated with the responsive record. For example, retrieved information regarding two or more responsive records can be displayed in list such that a row associated with the record includes the retrieved information associated with the record. The records can be organized in the list such that responsive records that represent better overall matches with the search query can be displayed higher in the list. For example, if two records are identified as responsive to a search query that includes two terms, information regarding a first record that includes information that matches both terms can be listed above information regarding a second record that includes information that matches only one of the search terms. Similarly, records with information that completely matches a search term can be ranked higher than records with information that only partially matches a search term. Alternatively, the list can be ordered according to another rank, or not according to rank, such as where the records are ranked according to departure time.

In order to identify the responsive records, the search engine 110 accesses one or more search rules stored in the search rule repository 150. The search engine 110 identifies one or more responsive records from among the categorized records by identifying information of one or more of the categorized records that matches the search term according to one or more of the search rules. Thus, the one or more records identified as responsive records include information for the determined category of information that at least partly matches at least part of the search term associated with the category. For example, the search engine 110 can identify a record as a responsive record according to a search rule associated with the “time” category only if time information included in the record indicates a time within 30 minutes from a time indicated in the search term associated with the “time” category. Other search rules may specify that only an exact match is sufficient to identify a record as responsive to the search term associated with the “time” category. Alternatively, any partial match may be sufficient. Other search rules may require or allow other types of matches as sufficient or necessary conditions for identifying a record as a responsive record.

Additionally, other search rules can provide other criteria used by the search engine 110 to identify responsive records. For example, if a search query includes two or more search terms, a search rule can cause the search engine to identify a categorized record as a responsive record only if the record includes information that matches both search terms according to search rules associated with the categories that are associated with the search terms. In other instances, a search rule can permit any record that includes information that matches any search term to be identified as a responsive record.

The search rules can also control the operation of the search engine by limiting a number of responsive records that can be identified. For example, after identifying fifty responsive records, a search rule can cause the search engine to stop attempting to identify additional records that have responsive information. In other instances, a search rule can allow the search engine 110 to identify all responsive records, rank the responsive records in descending order of responsiveness, or in another order, and retrieve information associated with the predetermined number of the highest-ranked responsive records.

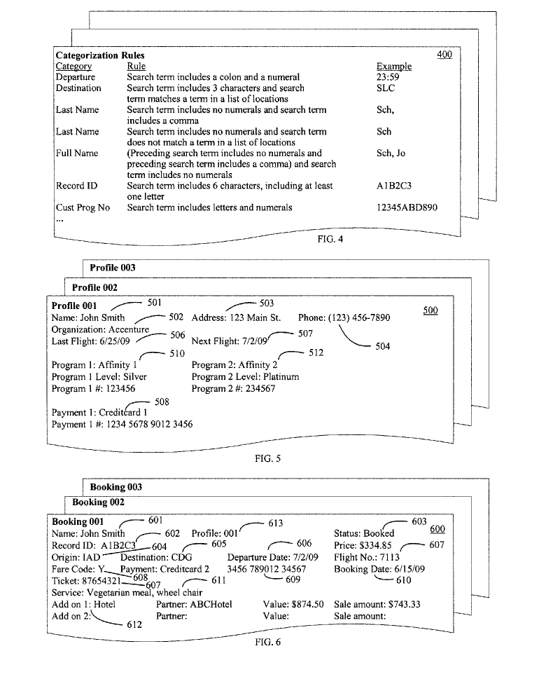

FIG. 3 illustrates an airline travel management system 300 that includes the search engine 110. The system 300 can be used, for example, for managing airline travel bookings. The system 300 includes a parsing rule manager 311, a categorization rule manager 321, a search rule manager 331, a travel record manager 341, one or more user terminals 351, and one or more airlines 361, which can communicate over a network 390. The network 390 may be or include one or more public or private, wired or wireless networks, such as the Internet.

The parsing rule manager 311 is operable to provide access to the parsing rules 120 stored in the parsing rule repository 120. For example, the parsing rule manager 311 can selectively provide grant permission to the search engine 110 to access the parsing rules such that the search engine 110 can use the parsing rules to identify one or more terms included in a search query, as described above. Additionally, the parsing rule manager 311 can provide access to the parsing rules to create new parsing rules and/or delete or modify existing parsing rules. For example, the airline 361, an administrator of the search engine 110, or another user can create parsing rules associated with the airline 361 that are to be used when parsing search queries provided by users that are associated with the airline 361. Similarly, the parsing rules can be modified or removed as desired.

The categorization rule manager 321 is operable to provide access to the categorization rules stored in the categorization rule repository 130. For example, the search engine 110 can be granted access to the categorization rules to categorize identified search terms, as described above. Additionally, a user associated with the airline 361 or another user can access the categorization rules to add, modify, and/or delete categorization rules. For example, users associated with different airlines can access the categorization rules to create airline-specific categorization rules that are to be used in categorizing search queries provided by users associated with the respective different airlines.

Similarly, the search rule manager 331 is operable to grant access to the search rules stored in the search rule repository 150 to enable the search engine 110 to search the categorized records stored in the categorized record repository 140 as described above, and to allow users to create, modify, and/or delete search rules.

The travel record manager 341 is operable to provide access to the categorized records to the search engine 110 such that the search engine 110 can records that are responsive to a received search query and provide information associated with the responsive records to a user. The travel record manager is also operable to maintain information regarding airline customers and travel reservation records, such as ticket sales. Thus, when a customer books travel on an airline, the travel record manager and/or the airline creates a new record in the categorized record repository and populates the record with information that is associated with the various categories of the categorized record. In some implementations, the creation and maintenance of the records of the categorized record repository is completely automated.

In use, the system 300 can be used for, among other things, retrieving information regarding the categorized records stored in the categorized record repository 140 that relate to completed and/or pending sales transactions for travel services. For example, a user, such as an airline employee can use the user terminal 351, such as a check-in terminal, to check-in a passenger arriving at an airport for a flight. In order to locate a record associated with the passenger, the user generates a search query. For example, the search query can include one or more terms regarding the passenger's name, destination, departure time, or other category of information, such as any other category of information included in the travel records stored on the categorized record repository 140. The search query can be, for example, a free-form user-generated query entered on a user interface of the user terminal 351, such as a search query typed or otherwise entered into a search control component of the user interface.

The search engine 110 can communicate with the user terminal 351 to receive search query. The search engine can also communicate with the parsing rule manager to access the parsing rules, the categorization rule manager 321 to access the categorization rules, the search rule manager to access the search rules, and the travel record manager to access the categorized travel records. As discussed above, the search engine 110 analyzes the format of at least one identified search term according to the categorization rules 130 to determine a category of travel information associated with the search term. The category of travel information can be selected from a predetermined set of possible categories which can include, for example, departure time, travel destination location, traveler name, travel record identifier, customer program account number, and a provider identifier.

The search engine 110 communicates with the travel record manager 341 to retrieve information regarding one or more travel records included in the categorized records 140, where the travel records include information for the determined category of travel information that at least partly matches at least part of the search query (e.g., the information may partially or fully match one or more search terms included in the search query). The retrieved information can be displayed on the user terminal 351.

The search engine 110 communicates with the search rule manager 331 to access one or more search rules 150. The search engine 110 can retrieve information from the categorized records according to the accessed search rules 150. A search rule 150 can include business logic which is applicable for searching a one or more categories of travel information. For example, a search rule can specify whether partial matching is applicable for a particular travel category (e.g., partial matching may be applicable for a travel destination location but might not be applicable for a customer program account number).

As discussed above, the parsing rule manager 311 provides access to the parsing rules 120. The parsing rule manager 311 can also provide a user interface and/or an Application Program Interface (API) for adding, updating, and deleting parsing rules 120. Similarly, the categorization rule manager 321 and the search rule manager 331 can provide a user interface and/or API for adding, updating, and deleting categorization rules 130 and search rules 150, respectively.

In some implementations, the categorized records 130 may be periodically updated. For example, one or more airlines 361 can periodically (e.g., every four hours) communicate with the travel record manager 341 to update the categorized records 140 to reflect a current state of travel records associated with the airlines 361 (e.g., to copy recent travel record transaction information for transactions occurring in systems of the airlines 361). In some implementations, the categorized records 140 may be a cache of travel information included in systems of the airlines 361. For example, the categorized records can include all records associated with flights scheduled for departure within 24 hours from a current time. Thus, the categorized record repository 140 can contain a moving window of travel records, and can be updated hourly to modify any travel records that have changed since the previous update and/or to add travel records associated with flights that are now scheduled for departure within 24 hours from the current time. Additionally, the categorized record repository can be updated on-demand, and/or automatically in response to a change in status, such as a cancellation of a flight that is scheduled to depart within 24 hours from the current time. For example, the categorized record repository can be updated based on a user selecting to search a time period that is outside the cached period.

In some implementations, some or all of the search engine 110, the parsing rule manager 311, the categorization rule manager 321, the search rule manager 331, and the travel record manager 341 are included in the same physical computing device. In some implementations, the search engine 110, the parsing rule manager 311, the categorization rule manager 321, the search rule manager 331, and the travel record manager 341 are included in different physical computing devices. In some implementations, some or all of the parsing rules 120, the categorization rules 130, and the search rules 150 may be stored in a data store local to (e.g., on the same physical machine as) the search engine 110. In some implementations, some or all of the parsing rules 120, the categorization rules 130, and the search rules 150 may be accessed over the network 390.

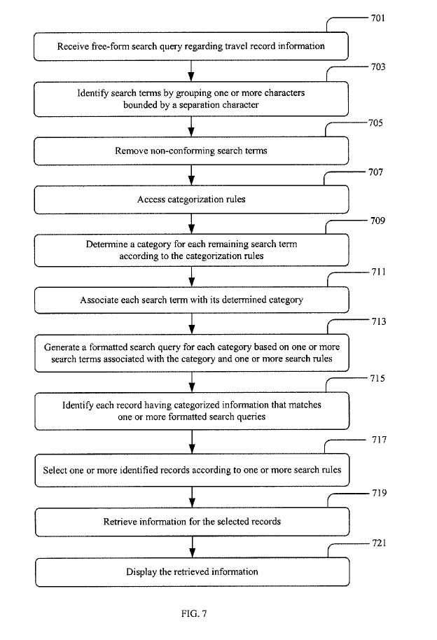

FIG. 4 is an illustration of example data structure 400 that includes categorization rules. As discussed above, a search engine (e.g., the search engine 110) may analyze the format of at least one identified search term according to the categorization rules 400 to determine a category of information associated with the search term. For example, a “departure” categorization rule specifies that a search term is to be associated with a departure time category if the search term includes a colon and a numeral (e.g., a search term of “23:59”). As another example, a “destination” categorization rule specifies that a search term is to be associated with a destination category if the search term includes exactly three characters and if the search term matches a destination code included in a list of predefined destination codes. For example, the destination category may be associated with a search term of “SLC”.

A “record identifier” categorization rule specifies that a search term is to be associated with a record identifier category if the search term includes exactly six characters and includes at least one letter. For example, a record identifier category may be associated with a search term of “A1B2C3”. A “customer program number” categorization rule specifies that a search term is to be associated with a customer program number category if the search term includes only letters and numerals. In this case, both a search term of “12345ABD890” and the search term of “A1B2C3” satisfy the categorization rule for the customer program number category, and, depending on other categorization rules, the search term of “A1B2C3” can be associated with only the record identifier category, only the customer program number category, or both.

If desired, more than one categorization rule may be associated with a particular category. For example, a first “last name” categorization rule specifies that a search term is to be associated with a last name category if the search term includes no numerals and includes a comma. For example, a last name category is associated with a search term of “Sch,”. Another last name categorization rule specifies that a last name category is to be associated with a search term if the search term includes no numerals and if the search term does not match a destination code included in a list of predefined destination codes.

A search engine may apply multiple categorization rules to a search term. For example, if a first categorization rule does not result in an association between a search term and a category, a search engine may apply a second categorization rule to the search term. A search engine may apply categorization rules in a particular order. For example, categorization rules which include relatively simple and fast determinations regarding matching records may be applied before categorization rules which include more complicated or longer determinations that are more resource intensive, such as a categorization rule that requires more processor cycles to identify matching records for a given number of records searched. For example, categorization rules for which matching results can be determined with fewer resources are applied first. For example, if a search term does not include six characters, it may be quickly determined that the search term does not match a record identifier category, or, as another example, if a search term does not include a colon, it may be quickly determined that the search term does not match a departure time category. Alternatively, the categorization rules can be applied in other selected orders based on other criteria, such as based on a determination of a category with which a search term is most likely to be associated.

Applying a categorization rule may involve multiple determinations. For example, when applying the destination categorization rule, a search engine may first determine if the search term includes three characters. If the search term does not include three characters, it may be determined that the search term is not associated with a destination category according to the categorization rule. If the search term includes three characters, a second determination may be made to determine whether the search term is included in a list of predefined destination codes.

Additionally, the categorization rules can be applied in an order such that a first categorization rule is applied after a second categorization rule where the second categorization rule involves a determination used by the first categorization rule. For example, the second last name categorization rule discussed above depends on the destination categorization rule because the second last name categorization rule specifies that a last name category may be determined for a search term if the search term does not match a destination code included in a list of predefined destination codes. Therefore, the second last name categorization rule can be applied after the destination categorization rule is applied to avoid making an unnecessary duplicate determination.

Some categorization rules may be applied to a combination of two or more search terms. For example, a “full name” categorization rule specifies that a search term is to be associated with a full name category if the first search term in a pair of terms includes no numerals and includes a comma, and if the second search term in the pair includes no numerals. For example, a full name category is associated with a compound search term of “Sch, Jo”, which includes a first search term of “Sch,” and second search term of “Jo”.

Any combination of logic may be used in applying a categorization rule, or a combination of categorization rules, to a search term. For example, if desired, each categorization rule can be applied to each search term or group of search terms to determine all possible associations of categories for each search term. Additionally, other categorization rules other than those shown in FIG. 4 are possible. For example, a flight number categorization rule may specify that a flight number category may be associated with a search term if the search term includes from one to four numerals and no other characters. As another example, a second full name categorization rule may specify that a full name category is to be associated with a pair of search terms if both the first and second search terms in the pair each include only letters and do not match a destination or other category. For example a full name category may be identified for a compound search term of “Joe Smith” because “Joe” and “Smith” include only letters and because “Joe” is not included on a list of destinations.

FIGS. 5 and 6 illustrate example categorized travel records that can be searched by the search engine 110 to identify travel records that are responsive to a search query. The categorized records 140 can include various types of travel information. For example, the categorized records 140 can include customer profile information and/or booking information. A customer profile record 500, illustrated in FIG. 5, includes demographic information, such as a customer name 501, an organization with which the customer is affiliated 502, an address 503, and one or more phone numbers 504. The customer profile record 500 also includes activity information, such as last flight information 506, next flight information 507, historic payment information 508, first reward program information 510, and second reward program information 512.

In some implementations, the information in the customer profile record 500 can be retrieved from multiple sources, aggregated into the customer profile record 500, and then stored in the categorized record repository 140. For example, the first reward program information 510 may be retrieved from a first airline, and the second reward program information 512 may be received from a second airline. As another example, multiple customer profile records 500 may exist in the categorized records 140 for a particular customer. For example, for each customer, a customer profile record for each airline may be stored in the categorized record repository 140.

An example booking record 600, illustrated in FIG. 6, includes information relating to pending or completed sale transactions of travel-related goods and/or services. For example, the example booking record 600 includes a customer name 601, a record identifier 602, a booking status 603, an origin location 604, a destination location 605, a departure date 606, a flight number 607, a fare code 608, payment information 609, a booking date 610, and information regarding past services provided or requested 611. The booking record 600 also includes add-on services information 612, such as information regarding an add-on service type, such as a car rental or hotel reservation, a partner add-on service provider, a value of the add-on service, and a sale amount. Other types of booking information may also be included. In some implementations, the booking record 600 is linked to a corresponding customer profile record 500, such as through a profile identifier 613 included in the booking record 600 that identifies a profile record 500 associated with the same customer.

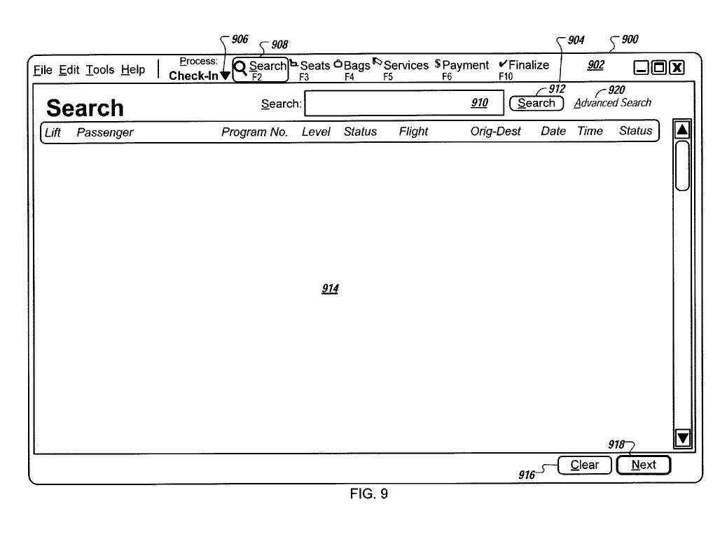

FIG. 7 is illustrates a process 700 for searching travel records. The search engine 110, or another processor, receives a free-form search query regarding travel record information (701). For example, a free-form search query may be received from a user terminal, such as the user terminal 351, and can be provided by an airline employee at a time of passenger check-in, boarding, or re-accommodation, such as when a flight is cancelled or is over-booked.

The search engine 110 identifies search terms by grouping one or more characters bounded by a separation character (703). For example, the search engine 110 may access the parsing rule repository 120 through the parsing rule manager 311 to retrieve an appropriate parsing rule for identifying search terms as groups of one or more characters bounded by a space character, another selected character, such as an asterisk, a dollar sign, or a percent symbol, or group of characters, such as two or more slashes, spaces, or asterisks. The search engine 110 removes or corrects non-conforming search terms (705). For example, the search engine 110 may recognize one or more search terms as being associated with a legacy system, such as if one or more search terms include one or more special characters or groups of characters typically used in such systems. Other examples of non-conforming search terms include search terms that include only one character, such as a number, or search terms that include unrecognized characters. The search engine 110 can, for some or all of the non-conforming search terms, correct the search term, such as by removing special characters, convert the non-conforming search term to a conforming search term using one or more parsing rules, or remove the search term from further processing. In some implementations, the search engine 110 may flag non-conforming search terms and prompt the user to the fix the non-conforming search terms.

The search engine 110 accesses categorization rules (707) and retrieves appropriate categorization rules for use in categorizing the identified search terms. For example, the search engine 110 accesses the categorization rule repository 130 through the categorization rule manager 321. In some implementations, the identity of the user or an airline associated with the user is used to select appropriate categorization rules, such as where airlines create and manage custom categorization rules. For example, an airline may define various roles, such as check-in agent, gate agent, reservations agent, and administrator, among others, and one or more roles may be associated with a user based on an employee identifier of the user, a location of a terminal being used, or based on another factor.

The search engine 110 determines at least one category for each remaining search term according to the categorization rules (709). For example, the search engine 110 may determine a category of travel information to be associated with a search term by analyzing a format of the search term according to a predetermined set of categorization rules. For example, as discussed above with respect to FIG. 4, the search engine 110 may analyze the format of each search term to determine, for example, whether the search term includes numbers, letters, letters and numbers. The number of characters in the search term can also be determined, as can the inclusion of a selected character, such as a wildcard character or a syntax character, such as a comma. The category of travel information to be associated with the search term is selected from a predetermined set of possible categories, which may include, for example, a departure time category, a travel destination location category, a passenger full name category, a passenger last name category, a travel record identifier category, a loyalty program account number category, and a provider identifier category.

The search engine 110 associates each search term with one or more determined categories (711). For example, an association between each search term and the determined categories can be represented in a data structure for subsequent use. The data structure may be stored in memory and/or in a data repository.

The search engine 110 generates a formatted search query for each category based on one or more identified search terms associated with the category and one or more search rules (713). For example, a formatted search query may be generated for a category by identifying a set of search terms which are associated with the category and generating a query condition string which includes an expression for each search term, such as a Boolean expression involving the search term. The expressions may be joined together using, for example, one or more Boolean operators or other logic operators.

The formatted search queries may be adjusted based on one or more search rules applicable to the category. For example, a search rule may specify that partial matches are applicable to the category (partial matches may not be applicable for all categories). Based on the search rule specifying that partial matches are applicable for the category, a wildcard character may be included in the formatted search query. As another example, if a search rule specifies that “close” matches are applicable for the category, a “like” operator or another operator may be included in the formatted search query.

Based on the formatted search queries, the search engine 110 identifies each record having categorized information that matches one or more formatted search queries (715). For example, one or more data repositories of categorized records associated with the category may be searched using the formatted search queries associated with the category. A data repository may be or include, for example, one or more data files of various file types, a data structure included in memory, a database, or a service which can be queried. For each formatted search query, one or more records which are returned from the search query may be, for example, appended to a data structure for subsequent display to the user.

The search engine 110 selects for output one or more identified records according to one or more search rules (717). For example, the search engine 110 can select a predetermined number of the identified records from each formatted search query. In some implementations, the search engine 110 ranks the identified records for each formatted search query according to a quality score or other measure of how well the information of the record matches the formatted search query, and a predetermined number of the top scoring records are selected. The search engine can identify records that were identified as responsive to more than search query and/or rank the selected results from all of the formatted search queries. A predetermined number of the highest ranked records and/or any records that were identified as responsive to two or more formatted search queries can be selected for output.

In some implementations, the selection of identified records can be conditional on various parameters of the user-generated search query and/or the set of identified results. For example, if more search terms are provided, resulting in a greater number of formatted search queries, fewer records from each category can be selected. In some implementations, the search engine 110 is configured to select all identified records if fewer than a predetermined number are identified, such as fewer than 20, and to select only 20 records if more than 20 records are identified. Additionally or alternatively, the search engine 110 can select a number of identified records for output that depends on the quality of one or more of the identified records, such as where only records having a score within a predetermined range from a highest scored record are selected.

The search engine retrieves information for each of the selected records (719). For example, all information included in each of the identified records is retrieved from a data structure that includes information for all records identified as responsive to at least one of the formatted search queries. In some implementations, the full set of information for a record is retrieved only after the selection of records for output to avoid unnecessary transfer of information of categorized records that are identified as responsive to a formatted search query, but which are not selected for output.

The retrieved information is displayed to the user (721). For example, the retrieved information may be displayed in a user interface, such as in a search results list. Alternatively, the retrieved information is displayed in another format, and/or less than all of the retrieved information is initially displayed, and all of the information included in a selected record is displayed only after a user inputs a command to display the information associated with one or more of the selected records.

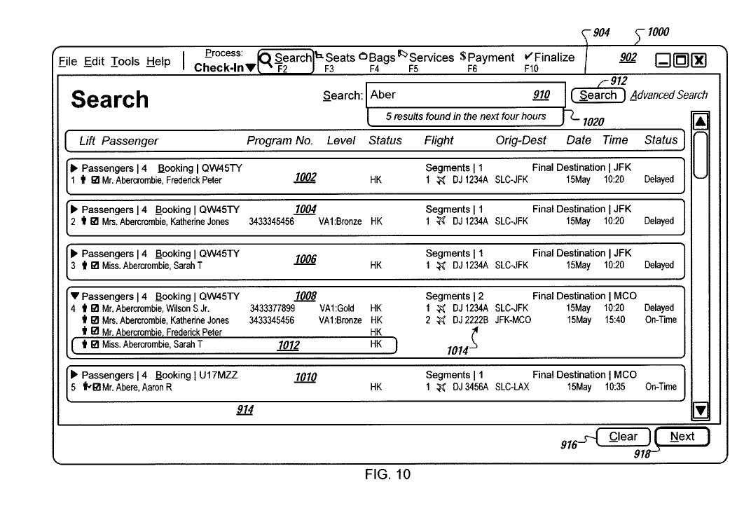

Referring to FIG. 8, the search engine 110 and/or components thereof, and one or more other components of the system 300 can be or include one or more computer systems, such as the computer system 800 of FIG. 8, or components thereof. The computer system 800 includes one or more processors 810, memory modules 820, storage devices 830, and input-output devices 840 connected by a system bus 850. The input-output devices 840 are operable with one or more peripheral devices 860, including a communication device that is operable to communicate with other computer systems or components thereof. Other peripheral devices that may be included in the computer system 800 include output devices such as displays, speakers, and printers, and input devices such as pointers, microphones, keyboards, and scanners. The one or more computer systems 800 or components thereof can perform the various functions described in this disclosure by executing computer instructions embodied in computer software stored on a computer-readable storage device, such as the memory modules 820, the storage devices 830, and/or the peripheral devices 860.

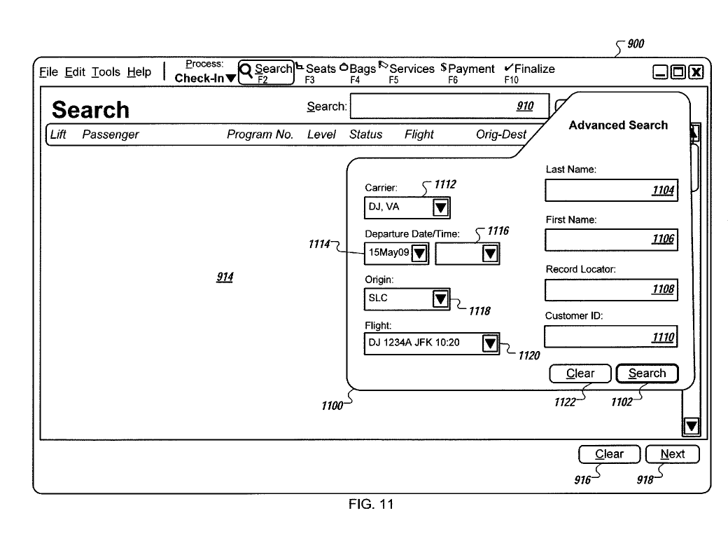

FIG. 9 illustrates a user interface 900 for searching travel records. The user interface 900 may be used, for example, by a gate agent or other employee or agent of an airline. The user interface 900 includes a menu toolbar 902 and a search area 904. The menu toolbar 902 includes various controls for initiating actions for airline passengers, such as checking-in passengers, assigning seats to passengers, checking-in luggage, accepting payment for tickets or other services, such as extra bag charges or seat upgrade charges, finalizing a check-in process, and/or performing other services. For example, a check-in process may be initiated by selecting a control 906. The search area 904 may be displayed in response to selection of a search control 908.

The search area 904 includes a search text input field 910, a search control button 912, a search results display area 914, a clear control button 916, a next control button 918, and an advanced search control button 920. Upon selection of the search control 908, a cursor focus is placed in the search text box 910, and the user is allowed to enter a free-form search query. The search control button 912 is disabled if the search text input field 910 does not include any search terms. A “tool tip” or other informative aid can be displayed, and an include examples of searches or other instructions for entering search terms.

After entering one or more search terms into the search text input field 910, the user can select the search control button 912. In response to the selection of the search control button 912, a search engine (e.g., the search engine 110) may perform a search process, such as the process 700 described above with respect to FIG. 7. Search results may be displayed in the search results display area 914. In some implementations, the search results display area 914 includes a portion associated with one or more of the categories of the categorized travel records to aid in organization of the display of the information of the displayed travel records. If no matching travel records are selected for output in response to the search query, a message indicating that no results are available can be displayed, such as in a message box or as message text displayed in the search results display area 914. If more than a predetermined number, such as two hundred, travel records are located by the search engine, a message indicating that too many results are available can be displayed, such as in a message box or as message text displayed in the search results display area 914. The predetermined number of search results that triggers the message can be configured, such as in a preferences or settings user interface.

A user can select the clear control button 916 to clear the search results display area 914 and the search text input field 910. A user can select the advanced search control button 920 to display an advanced search user interface, such as the advanced search user interface 1100 described below with respect to FIG. 11. If a user selects one or more travel records included in search results displayed in the search results display area 914, the next control button 918 can be enabled, and the user can select the next control button 918 to begin the check-in process or other process, such as re-accommodation, or modification of the travel records.

FIG. 10 illustrates a user interface 1000 for displaying information regarding categorized travel records as search results. Search results 1002-1010 are displayed, for example, in the search results display area 914, in response to the user selecting the search control button 912 after typing the search query “Aber” into the search text input field 910. As described above, user interface 1000 can be generated based on the a search process performed by the search engine 110, in which the search engine 110 identifies “Aber” as a search term, determines that a last name category is associated with the “Aber” search term, generates a formatted search query for identifying travel records, identifies each travel record in a categorized record repository (e.g., categorized record repository 140) that matches the formatted search query, retrieves information for the identified travel records, and displays the retrieved information as search results 1002-1010 in the search results display area 914.

In some implementations, a message may be displayed as the user inputs the search query that indicates, in an area 1020, a number of search results that will be returned for the search query currently entered in the search text input field 910. For example, a search engine may perform at least a portion of the process 700 and/or update a determination of a predicted number of results each time the text of the search text input field 910 changes. Additionally, the message can indicate another parameter relating to the results that will be returned. For example, the message can indicate the number of records that have a departure time within a particular window of time. In the example of FIG. 10, the search results 1002-1010 each include information regarding a last name that at least partially matches the search term “Aber.” As shown, the search results 1002-1008 are associated with a last name of “Abercrombie” and the search result 1010 is associated with a last name of “Abere”. Each of the search results 1002-1010 also include information for a flight reservation associated with the customer, such as lift status, passenger information, reward program information, a booking status, and flight segment information.

A number of navigation options are presented to the user for navigating the search results 1002-1010. For example, a user can expand or collapse a search result 1002-1010 to display more or less information, respectively, such as by selecting a left arrow key to collapse a selected search result and by selecting a right arrow key to expand a selected search result. The search result 1008 is shown in an expanded state and the search results 1002, 1004, 1006, and 1010 are shown in a collapsed state.

As another example, in some implementations, for search results which include more than one passenger, a user can move a selection focus to a desired one of the passengers included in the search result, such as by pressing up and down arrow keys. For example, a passenger 1012 who's name information is “Miss Sarah Abercrombie”, is selected in the search result 1008. If the top passenger of an expanded result is selected and the up arrow key is pressed, a prior search result from the list may be selected, and if the bottom passenger of a search result is selected and the down arrow key is pressed, a subsequent search result of the list may be selected. For example, with the passenger 1012 selected, if the user presses the down arrow key, then the search result 1010 may be selected. If a passenger is selected, the next control button 918 can be enabled to allow the user to proceed to a next step in the check-in process by selecting the next control button 918.

As mentioned above, a search result can also include a list of flight segments. For example, a passenger list included in the search result 1008 includes two flight segments 1014. A user can navigate between flight segments in a manner similar to navigating between passengers (e.g., using the up and down arrow keys). In some implementations, a user can toggle focus between the passenger list in a search result and the flight segment list in the search result, such as by pressing the right arrow key again. Alternatively, other keys or input techniques can be used for navigation.

FIG. 11 illustrates a user interface 1100 for performing an advanced search of travel records. The user interface 1100 may be displayed, for example, in response to selection of the advanced search control button 920 included on the user interface 900. In some implementations, the user interface 1100 is displayed over the user interface 900 in an overlaid style. The user interface 1100 includes a search control button 1102 and categorized input entry fields 1104-1120, which may be used to enter a last name, first name, record locator, customer identifier, carrier, departure date, departure time, origin, and flight information, respectively.

The last name input entry field 1104 and first name input entry field 1106, and possibly others of the input entry fields 1108-1120, are automatically populated with one or more search terms based on a search query entered the search text entry field 910 of the user interface 900. To determine the values to include in the input entry fields 1104-1120, the search engine 110 or another search engine performs at least part of a search process to process the search query.

The carrier input field 1112 can be automatically populated with one or more characters or terms associated with one or more carriers, such as a airline of which the user is an employee, or one or more carriers specified in a system setting. The departure date input field 1114 can be automatically populated to include, by default, the current date. The departure time input field 1116 can be blank by default, such that all times of the selected date will be searched, unless the user changes the departure time using the departure time input field 1116. The origin location input field 1118 can be automatically populated using a value representing the location of the terminal used to display the user interface 1110, such as the airport where the user interface 1100 is being used. The flight number input field 1120 can remain blank by default, unless a term included in the input field 910 is determined to be associated with the flight number category. The user can input the flight number into the input field 1120 to look up a flight, such as by entering and/or selecting some or all of a carrier code, a flight number including an operations suffix, a destination, and a scheduled departure time.

After entering and/or modifying the terms input in one or more of the input fields 1104-1120, the user can select the search control button 1102 to perform a search for travel records based on the contents of the input fields 1104-1120. For example, the search engine 110 performs a search process to identify travel records that include information that matches one or more formatted search queries that are generated based on the input terms. Upon selection of the search control button 1102, the user interface 1100 may be hidden or removed such that the display returns to the user interface 900. Search results may be displayed in the search results display area 914. If a user selects one or more passengers included in search results displayed in the search results display area 914, the next control button 918 becomes enabled, and the user can select the next control button 918 to proceed with the check-in process. The user can select a clear control button 1122 to remove input information from the input fields 1104-1120.

While some implementations are described above, these should not be viewed as exhaustive or limiting, but rather should be viewed as exemplary, and are included to provide descriptions of various features. It will be understood that various modifications may be made. For example, the steps of the described exemplary processes can be performed by one or more different entities, systems, and or system components. Similarly, other components that are described as separate can be combined, and components can include multiple separate sub-components. With regard to the processes described above, the steps of the described processes can be performed in any order that achieves the described results.

Accordingly, other implementations are within the scope of the following claims.

1. A method, comprising:
receiving a search query including at least one search term relating to information included in travel records;
identifying, by one or more computer processors, one or more search terms included in the search query;
determining, for at least one identified search term included in the search query by one or more computer processors, a category of travel information associated with the search term by analyzing a format of the search term and selecting a category of travel information according to a predetermined set of categorization rules;
retrieving, from a travel record repository by one or more computer processors, information regarding one or more travel records, the one or more travel records including information for the determined category of travel information that at least partly matches at least part of the search query; and
outputting the retrieved information in response to the search query.

2. The method of claim 1, wherein identifying one or more search terms includes analyzing a syntax of the search query to identify a pattern that corresponds to a search term.

3. The method of claim 1, wherein the predetermined set of categorization rules includes one or more rules regarding selecting a category to be applied to the search term when the search term meets one or more criteria associated with at least two categories.

4. The method of claim 1, wherein the category of travel information is selected from a predetermined set of possible categories.

5. The method of claim 4, wherein the predetermined set of possible categories includes at least one of departure time, travel destination location, traveler name, travel record identifier, customer program account number, and a provider identifier.

6. The method of claim 1, wherein the received query comprises a free-form user-generated query.

7. The method of claim 1, wherein the travel record repository includes categorized information for travel records.

8. The method of claim 1, wherein retrieving information regarding one or more travel records includes retrieving information from the travel record repository according to a search rule associated with the determined category.

9. The method of claim 1, wherein the travel records are associated with pending or completed sale transactions of one or more affiliated providers of travel-related goods and/or services.

10. The method of claim 1, wherein determining comprises determining that an identified search term included in the search query consisting of three letters is associated with a destination category.

11. A system comprising:
one or more receivers that receive a search query including at least one search term relating to information included in travel records;
one or more computer processors that identify one or more search terms included in the search query, determine, for at least one identified search term included in the search query, a category of travel information associated with the search term by analyzing a format of the search term and selecting a category of travel information according to a predetermined set of categorization rules, and retrieve, from a travel record repository, information regarding one or more travel records, the one or more travel records including information for the determined category of travel information that at least partly matches at least part of the search query; and
one or more output devices that output the retrieved information.

12. The system of claim 11, wherein identifying one or more search terms includes analyzing a syntax of the search query to identify a pattern that corresponds to a search term.

13. The system of claim 11, wherein the predetermined set of categorization rules includes one or more rules regarding selecting a category to be applied to the search term when the search term meets one or more criteria associated with at least two categories.

14. The system of claim 11, wherein the category of travel information is selected from a predetermined set of possible categories.

15. The system of claim 14, wherein the predetermined set of possible categories includes at least one of departure time, travel destination location, traveler name, travel record identifier, customer program account number, and a provider identifier.

16. The system of claim 11, wherein the received query comprises a free-form user-generated query.

17. The system of claim 11, wherein the travel record repository includes categorized information for travel records.

18. The system of claim 11, wherein the travel records are associated with pending or completed sale transactions of one or more affiliated providers of travel-related goods and/or services.

19. The system of claim 11, further comprising one or more storage devices that store information included in the travel record repository.

20. A tangible computer-readable medium that includes computer software stored thereon, the computer software including computer-executable instructions that, when executed by one or more computer processors, cause one or more computer systems to:
receive a search query including at least one search term relating to information included in travel records;
identify, by one or more computer processors, one or more search terms included in the search query;
determine, for at least one identified search term included in the search query by one or more computer processors, a category of travel information associated with the search term by analyzing a format of the search term and selecting a category of travel information according to a predetermined set of categorization rules;
retrieve, from a travel record repository by one or more computer processors, information regarding one or more travel records, the one or more travel records including information for the determined category of travel information that at least partly matches at least part of the search query; and
output the retrieved information in response to the search query.

21. A tangible computer-readable medium that includes computer software stored thereon, the computer software including computer-executable instructions that, when executed by one or more computer processors, cause one or more computer systems to:
provide a first user interface having a search text input field and an advanced search control;
receive information regarding user input in the search text input field and an indication that the advanced search control was selected; and
provide a second user interface having categorized input entry fields,
wherein at least one of the categorized input entry field is automatically populated based on the received information.
